(19) United States
(12) Patent Application Publication
(10) Pub. No.: US 2013/0003111 A1
(43) Pub. Date: Jan. 3, 2013

(54) METHOD AND SYSTEM FOR NETWORK DIAGNOSTICS WHICH SHOWS POSSIBLE CAUSES ON A DISPLAY OF AN IMAGE FORMING APPARATUS

(75) Inventor: Toshiyuki MITSUBORI, San Mateo, CA (US)

(73) Assignee: KONICA MINOLTA LABORATORY U.S.A., INC., San Mateo, CA (US)

(21) Appl. No.: 13/174,292

(22) Filed: Jun. 30, 2011

(51) Int. Cl. G06K 15/02

(52) U.S. Cl. 358/1.15

(57) ABSTRACT

A method of detecting and displaying network status for an image forming system having an image forming apparatus and a printer controller. The method includes the steps of connecting the printer controller with the image forming apparatus through a first line which a client sends a print job to the printer controller and a second line which transfers the image data. Upon detection of a failure in network connectivity through the first line, transmitting messages from the printer controller and image forming apparatus to the printer controller and the image forming apparatus. The messages sent and received by the printer controller and the image forming apparatus are gathered and based on the gathered messages received and not received by the image forming apparatus and the printer controller, a cause of the failure is detected.

### FIELD OF THE INVENTION

The present invention relates to a system and method for detecting and displaying network status for an image forming system having an image forming apparatus and a printer controller, and more particularly, a system and method for detecting and displaying network status for an image forming system having an image forming apparatus and a printer controller, which has an automatic (or auto) network diagnostic feature, which shows possible causes on a display of an image forming apparatus or multi-function peripheral (MFP).

### BACKGROUND OF THE INVENTION

There has been a widespread use of the printing apparatus (hereinafter referred to as “image forming apparatus) of a multi-functional peripheral provided with a printer function and a scanner function. When the image forming apparatus is used for printing operations, a print job of page description language (PDL: Page Description Language) format is received from a client or client device. The client or client device is typically linked to the image forming apparatus via a network. Once the print job is received by the image forming apparatus, the print job is raterized (bit map expansion) to generate multivalued (e.g., 8 bits) image data. This multivalued image data is screened (binarized) to generate binary image data, and image adjustment processing is applied to the binary image data, which is then outputted onto a print medium and/or paper medium.

In the system connected with a plurality of image forming apparatuses via the network, if the process of generating multivalued image data from a print job (hereinafter referred to as “RIP (Raster Image Processor) processing”) or the process of screening the multivalued image data is to be performed in each image forming apparatus, each image forming apparatus is required to have the functions of performing the above-mentioned processes. This can result in a complicated structure of the image forming apparatus. Accordingly, to avoid these problems, as set forth in commonly owned, U.S. Patent Publication No. 2009/0251726, an image forming system was designed in which a separate printer controller is provided with the above-mentioned RIP processing function and screening function is linked with the network, and the printer controller exclusively takes charge of the above-mentioned processes.

In a configuration as described above, which includes a client or client device, a separate printer controller, and an image forming apparatus, if the network connectivity between the printer controller and the image forming apparatus is down and/or is not working properly, it would be desirable to have a network diagnostic feature, which automatically shows the possible causes of the network failure on a display or graphical user interface (GUI) of the image forming apparatus so that the necessary repairs can be made.

### SUMMARY OF THE INVENTION

In consideration of the above issues, it would be desirable to have a system and method for detecting and displaying the network status for an image forming system having an image forming apparatus and a printer controller, which includes an automatic network diagnostic feature, which shows possible causes on a display of an image forming apparatus or multi-function peripheral (MFP).

In accordance with an exemplary embodiment, a method of detecting and displaying network status for an image forming system having an image forming apparatus and a printer controller, the method comprises: connecting the printer controller with the image forming apparatus through a first line which a client sends a print job to the printer controller and a second line which transfers the image data; upon detection of a failure in network connectivity between the printer controller and the image forming apparatus through the first line, transmitting messages from the printer controller to the printer controller and the image forming apparatus via the first line, and transmitting messages from the image forming apparatus to the printer controller and the image forming apparatus via the first line, wherein upon receipt of the messages, the printer controller and the image forming apparatus receiving the messages sends via the second line a return message to the printer controller or image forming apparatus which originated the message; detecting if the messages sent from the printer controller and the image forming apparatus are received by the printer controller and/or the image forming apparatus by receiving via the first line a return message from the printer controller and/or the image forming apparatus; gathering via the second line the messages sent by the printer controller and the image forming apparatus, which are received by the printer controller and the image forming apparatus via the return message, and messages sent by the printer controller and the image forming apparatus, which do not return to the printer controller and the image forming apparatus; and detecting a cause of the failure in the network connectivity between the printer controller and the image forming apparatus based on the gathered messages received and not received by the image forming apparatus and the printer controller.

In accordance with a further exemplary embodiment, an image forming system comprises: a printer controller which generates image data based on a print job, the printer controller having a diagnostic module; an image forming apparatus which controls the printer controller and performs a printing operation based on the image data, and wherein the printer controller is connected with the image forming apparatus through a first line which a client sends a print job to the printer controller and a second line which transfers the image data; and wherein the printer controller and the image forming apparatus perform the following steps: connecting the printer controller with the image forming apparatus through the first line which the client sends the print job to the printer controller and the second line which transfers the image data; upon detection of a failure in network connectivity between the printer controller and the image forming apparatus through the first line, transmitting messages from the printer controller to the printer controller and the image forming apparatus via the first line, and transmitting messages from the image forming apparatus to the printer controller and the image forming apparatus via the first line, wherein upon receipt of the messages, the printer controller and the image forming apparatus receiving the messages sends via the first line a return message to the printer controller or image forming apparatus which originated the message; detecting if the messages sent from the printer controller and the image forming apparatus are received by the printer controller and/or the image forming apparatus by receiving via the first line a return message from the printer controller and/or the image forming apparatus; gathering via the second line the messages sent by the printer controller and the image forming apparatus, which are received by the printer controller and the image forming apparatus via the return message, and messages sent by the printer controller and the image forming apparatus, which do not return to the printer controller and the image forming apparatus; and detecting a cause of the failure in the network connectivity between the printer controller and the image forming apparatus based on the gathered messages received and not received by the image forming apparatus and the printer controller.

In accordance with another exemplary embodiment, a computer program product comprising a non-transitory computer usable medium having a computer readable code embodied therein for detecting and displaying network status for an image forming system having an image forming apparatus and a printer controller, the computer readable program code configured to execute a process, which includes the steps of: connecting the printer controller with the image forming apparatus through a first line which a client sends a print job to the printer controller and a second line which transfers the image data; upon detection of a failure in network connectivity between the printer controller and the image forming apparatus through the first line, transmitting messages from the printer controller to the printer controller and the image forming apparatus via the first line, and transmitting messages from the image forming apparatus to the printer controller and the image forming apparatus via the first line, wherein upon receipt of the messages, the printer controller and the image forming apparatus receiving the messages sends via the first line a return message to the printer controller or image forming apparatus which originated the message; detecting if the messages sent from the printer controller and the image forming apparatus are received by the printer controller and/or the image forming apparatus by receiving via the first line a return message from the printer controller and/or the image forming apparatus; gathering via the second line the messages sent by the printer controller and the image forming apparatus, which are received by the printer controller and the image forming apparatus via the return message, and messages sent by the printer controller and the image forming apparatus, which do not return to the printer controller and the image forming apparatus; and detecting a cause of the failure in the network connectivity between the printer controller and the image forming apparatus based on the gathered messages received and not received by the image forming apparatus and the printer controller.

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an illustration of a data processing system having a plurality of client devices and an image forming system, which includes an image forming apparatus and a printer controller in accordance with an exemplary embodiment.

FIG. 2 is an illustration of a data processing system, which includes an image forming apparatus and a printer controller in accordance with an exemplary embodiment.

FIG. 3 is an illustration of a data processing system, which includes an image forming apparatus, a printer controller, and a hub in accordance with another embodiment.

FIG. 4 is an illustration of a data processing system, which includes an image forming apparatus, a printer controller, and one or more hubs in accordance with another embodiment.

FIG. 5 is an illustration of a graphical user interface (or display) for an image forming apparatus in accordance with a further embodiment.

FIG. 6 is an illustration of a sequence diagram for an automatic network diagnostic feature in accordance with an embodiment.

FIG. 7 is an illustration of a sequence diagram for an automatic network diagnostic feature in accordance with another embodiment.

FIG. 8 is an illustration of a flowchart, which describes the automatic network diagnostic feature in accordance with an exemplary embodiment.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In accordance with an exemplary embodiment, a method of detecting and displaying network status for an image forming system having an image forming apparatus and a printer controller is described herein. The method includes connecting the printer controller with the image forming apparatus through a first line which a client sends a print job to the printer controller and a second line which transfers the image data. Upon detection of a failure in network connectivity between the printer controller and the image forming apparatus through the first line, transmitting messages from the printer controller to the printer controller and the image forming apparatus via the first line. In addition, messages are transmitted from the image forming apparatus to the printer controller and the image forming apparatus via the first line, wherein upon receipt of the messages, the printer controller and the image forming apparatus receiving the messages sends via the first line a return message to the printer controller or image forming apparatus which originated the message. If the messages sent from the printer controller and the image forming apparatus are received by the printer controller and/or the image forming apparatus by receiving a return message from the printer controller and/or the image forming apparatus, the messages sent by the printer controller and the image forming apparatus, which are received by the printer controller and the image forming apparatus via the return message, and messages sent by the printer controller and the image forming apparatus, which are not return to the printer controller and the image forming apparatus are gathered via the second line. A cause of the failure in the network connectivity between the printer controller and the image forming apparatus is detected based on the gathered messages received and not received by the image forming apparatus and the printer controller.

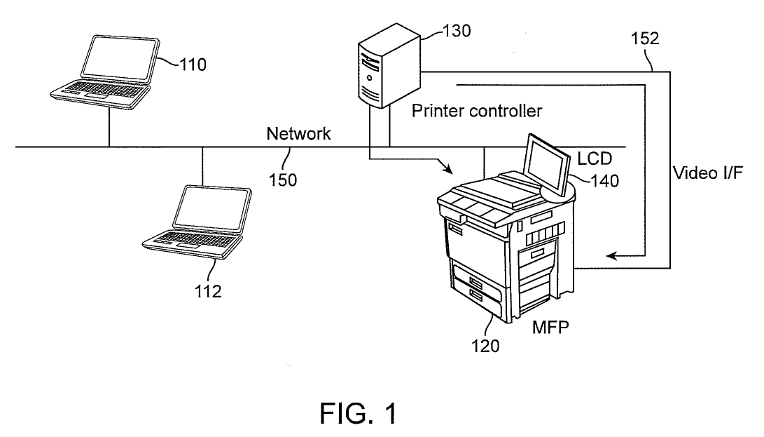

FIG. 1 is an illustration of an image forming system 100, which includes one or more clients or client devices, 110, 112, an image forming apparatus 120, and a separate printer controller 130. As shown in FIG. 1, the one or more clients 110, 112, the image forming apparatus 120, and the printer controller 130 are connected via a first line (i.e., an Internet or network connection) 150, such as a LAN (Local Area Network) or WAN (Wide Area Network). In addition, the image forming apparatus 120 and the printer controller 130 are connected via a second line 152, such as a dedicated bus or video I/F cable (video interface cable).

In accordance with an embodiment, the printer controller 130 receives a print job of page description language format from the one or more clients 110, 112 through the first line 150, and applies RIP processing or screening processing. The binary image data and job ticket are then sent to the image forming apparatus 120 via the second line 152. In the image forming apparatus 120, image adjustment processing is applied to the binary image data, and printing is carried out.

In accordance with an exemplary embodiment, the printer controller 130 does not include a display section or operation section. Accordingly, a display or display panel (i.e., graphical user interface or GUI) 140 associated with the image forming apparatus 120 can be used to perform the following functions within the printer controller 130, which includes setting the IP (Internet Protocol) address of the printer controller 130, registering the information of the image forming apparatus 120 or user information into the printer controller 130, controlling the print job, and updating the program of the printer controller 130.

In accordance with an exemplary embodiment, each of the one or more client devices 110, 112 preferably include a processor or central processing unit (CPU), one or more memories for storing software programs and data (such as files to be printed). The client devices 110, 112 also preferably include an operating system (OS), which manages the computer hardware and provides common services for efficient execution of various software programs. The processor or CPU carries out the instructions of a computer program, which operates and/or controls at least a portion of the functionality of the client devices 110, 112. Examples of client devices 110, 112 include and are not limited to personal computers, image forming apparatuses, routers, and/or personal digital assistants (PDAs).

The one or more clients 110, 112 creates a print job of PDL format using a printer driver. In accordance with an exemplary embodiment, the print job is sent via the first line 150 to the printer controller 130. In accordance with an embodiment, the first line 150, which connects the one or more client devices 110, 112, the image forming apparatus 120 and/or the printer controller 130 can be a wire (or cable) and/or wireless technology including but not limited to radio frequency (RF) and/or infrared (IR) transmission.

As described above, when a printer controller 130 is installed, the one or more client devices 110, 112, the image forming apparatus 120, and the printer controller 130 are connected via a first line 150 such as LAN or WAN. The image forming apparatus 120 and the printer controller 130 are also connected or linked via the second line 152, which is preferably a dedicated bus line, such as a video I/F (interface) cable. Since the printer controller 130 has no other UI (User Interface) than video display or display panel 140 of the image forming apparatus 120, a command code is transferred via the second line 152 to perform various forms of settings.

In accordance with an exemplary embodiment, a Web server is mounted on the printer controller 130, and a Web browser is mounted on the image forming apparatus 120 so that the printer controller 130 can be controlled using the first line 150. Further, the display 140 for controlling the printer controller 130 is created by the printer controller 130 not by the image forming apparatus 120, and the aforementioned display panel 140 is displayed by the Web browser function of the image forming apparatus 120. In the above-mentioned configuration, the basic setting including the IP address required by the Web browser must be performed on the operation section of the image forming apparatus 120. When the printer controller 130 is connected, the basic setting (what is called initial setting) including the IP address is performed using the second line 152 such as a dedicated bus. In this case, the screen data for initial setting is stored in the storage section of the image forming apparatus 120.

When the print job is set on the image forming apparatus 120, information on the connection of the printer controller 130 is checked. If the initial setting is not yet completed, the setting is prompted. If initial setting has been completed, the Web browser is booted, and the Web page of the printer controller 130 is specified and notified to the URL (Uniform Resource Locator) so that the display panel is available and the connection is started. When there is access to the Web browser from the relevant image forming apparatus 120, the Web server of the printer controller 130 returns the page contents in conformity to that Web browser. For example, the command code to be sent from the image forming apparatus 120 to the printer controller 130 is designed to contain the information (e.g., tag, image format and CGI (Common Gateway Interface)) that can be displayed on the Web browser. This arrangement allows the printer controller 130 to identify the Web browser function of the image forming apparatus 120 and to send appropriate Web page as a reply.

Further, the image forming apparatus 120 can retain the basic setting information including the ID information of the printer controller 130 connected, as well as the information on the current status of connection. The command code, for example, at the time of re-installation of the printer controller 130 can be automatically sent again, and the screen set by the Web browser can be used, without explicit setting by the user.

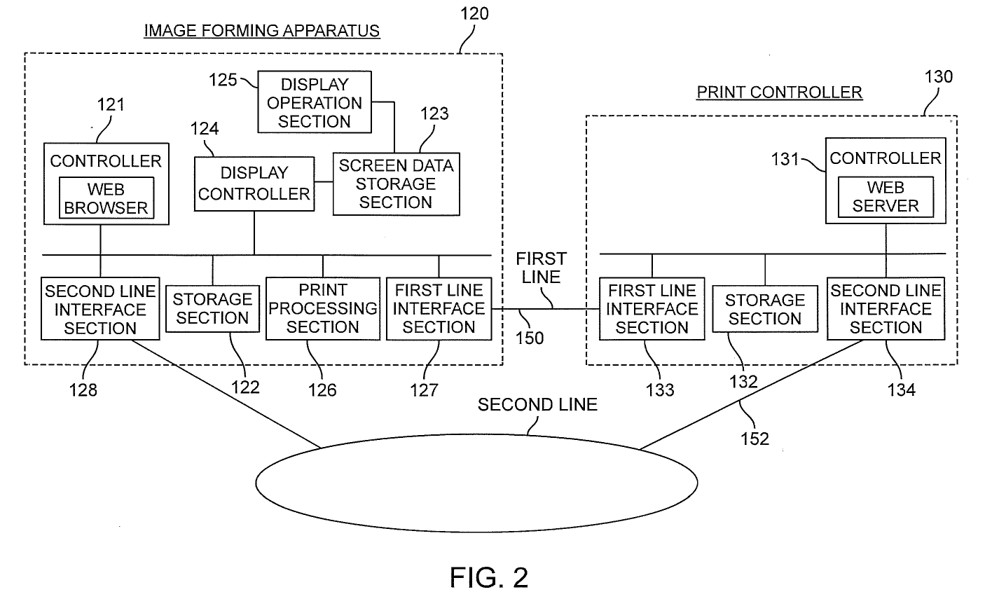

FIG. 2 is an illustration of a data processing system 200, which includes an image forming apparatus 120 and a printer controller 130. As shown in FIG. 2, the image forming apparatus 120 includes a controller 121, a storage section 122, a screen data storage section 123, a display controller 124, a display operation section 125, a print processing section 126, a first line interface section 127 and a second line interface section 128.

The controller 121 typically includes a central processing unit (CPU), a random access memory (RAM), and a read only memory (ROM). The central processing unit is configured to execute a sequence of stored instructions (i.e., a computer program). The controller 121 also includes an operating system (OS), which acts as an intermediary between the software programs and hardware components within the image forming apparatus 120. The operating system (OS) manages the computer hardware and provides common services for efficient execution of various application software. In accordance with an exemplary embodiment, the controller 121 can provide additional assistance to the printer controller 130 by processing the data and job information received from the printer controller 130 via the client devices 110, 112 to generate a print image. The controller 121 applies processing of compression, decompression, enlargement, reduction and rotation to the image data obtained from the printer controller 130. Further, the controller 121 serves as a Web browser that obtains a Web page from the printer controller 130. The controller 121 also includes a diagnostic module, which performs the steps of detecting and displaying network status for an image forming system having an image forming apparatus 120 and a printer controller 130 as described herein.

The storage section 122 preferably includes an HDD (Hard Disk Drive) and/or other storage medium, and stores the processed image data, the setting information of the image forming apparatus 120, and user information. The screen data storage section 123 preferably includes a VRAM (Video Random Access Memory) and stores the screen data to perform setting (e.g., IP address setting, and registration of the information of the image forming apparatus 120 and user information, hereinafter referred to as “initial setting”) that allows the printer controller 130 to be used via the first line 150, and the screen data obtained from the printer controller 130 using a Web browser. The display controller 124 controls the display operation section 125, and can be exemplified by an LCD (Liquid Crystal Display) controller. In accordance with an exemplary embodiment, the display operation section 125 is composed of a pressure sensitive operation section (touch display panel) having transparent electrodes arranged in a grid-like configuration, wherein this pressure sensitive operation section is mounted on the LCD or organic EL (electroluminescence) display. The X-Y coordinates at the point wherein force is applied by depression with a finger or a touch pen are detected in terms of the current value, and the position signal having been detected is outputted as an operation signal into the controller 121.

The print processing section 126 transfers the image data to print medium, such as paper. In accordance with an exemplary embodiment, the photoreceptor drum charged by a charging device is exposed to the light corresponding to the image by the exposure apparatus so that an electrostatic latent image is formed. Then the toner charged by a development apparatus is attached thereto so as to cause development. This toner image is transferred onto the transfer belt in the primary step, and is then transferred from the transfer belt onto the paper medium in the secondary step. Further, the toner image is fixed onto a paper medium by the fixing apparatus. If required, folding, book binding and stapling operations are performed.

The first line interface section 127 is an interface of the NIC (Network Interface Card) or modem for connection with the first line 150, and communicates with the one or more clients 110, 112, the image forming apparatus 120, and the printer controller 130 in conformity to the Ethernet® standards. The second line interface section 128 constitutes an interface for connection with the second line 152, and communicates with the printer controller 130 in conformity to the PCI (Peripheral Component Interconnect) standards and others.

The printer controller 130 includes a controller 131, a storage section 132, a first line interface section 133 and a second line interface section 134. The controller 131 includes a CPU (Central Processing Unit), RAM (Random Access Memory) and ROM (Read Only Memory). The controller 131 also includes a diagnostic module, which performs the steps as described herein for detecting and displaying network status for an image forming system having an image forming apparatus 120 and a printer controller 130 as described herein. In accordance with an exemplary embodiment, the controller 131 applies RIP processing or screening to the print data obtained from the one or more clients 110, 112, whereby image data is generated. Further, the controller 131 serves the functions of a Web server such as an HTTP (Hypertext Transfer Protocol) server that creates screen data for controlling the printer controller 130, converts the screen data into a predetermined format (e.g., HTML (Hypertext Markup Language) format), and supplies the data to the image forming apparatus 120 in the form of a Web page.

The storage section 132 is made of an HDD (Hard Disk Drive) and other storage medium, and serves to store the print job obtained from the one or more clients 110, 112 and the image data sent to the image forming apparatus 120. The first line interface section 133 constitutes an interface of the NIC (Network Interface Card) or modem for connection to the first line 150, and communicates with the one or more clients 110, 112 and image forming apparatus 120 in conformity to the standards of the Ethernet®. The second line interface section 134 constitutes an interface for connection to the second line 152, and communicates with the image forming apparatus 120 in conformity to the standards such as PCI.

The first interface provides communications between the printer section and the client device 110 and receives page descriptions (or print data) from the client devices 110, 112 for processing within the image forming apparatus 120 and/or printer controller 130. In accordance with an exemplary embodiment, the operation of printer controller 130 commences when it receives a page description from one of the client devices 110, 112 in the form of a print job data stream. The page description may be any kind of page description languages (PDLs), such as PostScript® (PS), Printer Control Language (PCL), Portable Document Format (PDF), and/or XML Paper Specification (XPS). Examples of image forming apparatuses 120 consistent with exemplary embodiments of the invention include industrial printers, and/or multi-function printers or peripherals (MFP).

In accordance with an exemplary embodiment, the image forming apparatus 120 receives the printer controller 130 panel information as HTTP data via the first line 150 (i.e., via the network connection). In accordance with an exemplary embodiment, the display panel 140 (e.g., Liquid Crystal Display) can display the status of the printer controller 130 using the Web browser function associated with the image forming apparatus 120. However, if the first line 150 has something wrong with the connection, the display panel 140 will be unable to display the status of the printer controller 130. Accordingly, it would be desirable to have a method and system, which can automatically diagnose errors in the system 100 after a failure in the network connectivity is detected.

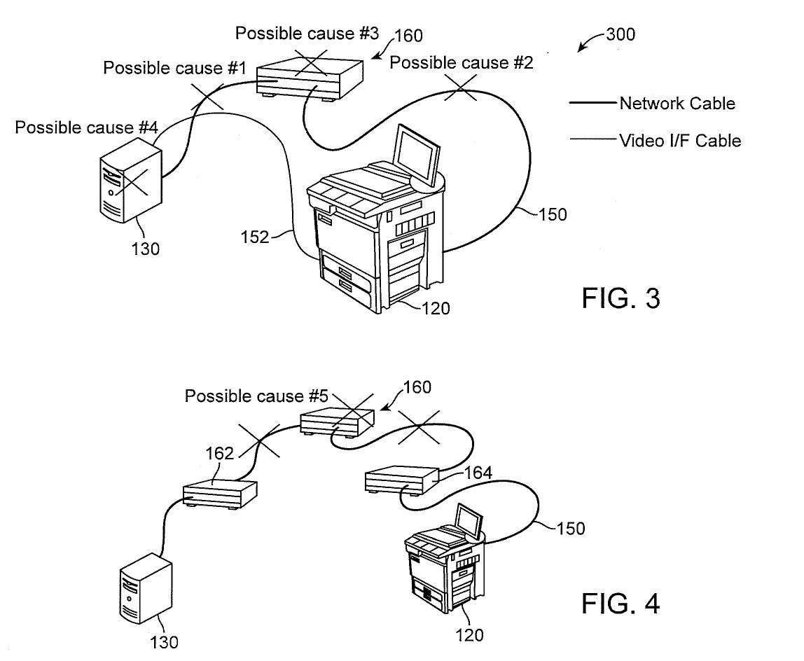

FIG. 3 is an illustration of another exemplary data processing system 300, which includes an image forming apparatus 120, a printer controller 130, and at least one hub 160. As shown in FIG. 3, the data processing system 300 includes at least one hub 160, which can be any suitable device that joins one or more computer devices such as the image forming apparatus 120 and the printer controller 130 together. In accordance with an exemplary embodiment, the at least one hub 160 preferably supports the Ethernet standard. As shown in FIG. 3, the printer controller 130 is connected to the hub 160 via the first line (i.e., a network cable) 150. In addition, the printer controller 130 is connected via the second line 152 (i.e., Video Interface cable) to the image forming apparatus 120.

FIG. 4 is an illustration of a further exemplary data processing system 400, which includes an image forming apparatus 120, a printer controller 130, and a plurality of hubs 160, 162, 164. As shown in FIG. 4, the data processing system 400 includes a plurality of hubs 160, a printer controller 130, and an image forming apparatus 120. In accordance with an exemplary embodiment, the one or more hubs 160, 162, 164 preferably support the Ethernet standard. As shown in FIG. 4, the printer controller 130 is connected via a first line (i.e., a network cable) 150 to the plurality of hubs 160, 162, 164. In accordance with an exemplary embodiment, each of the plurality of hubs 160, 162, 164 are connected in series to one another, and the printer controller 130 and image forming apparatus 120. In addition, the printer controller 130 is connected to the image forming apparatus 120 via a second line (i.e., a video I/F cable) 152.

If a network failure is detected in the data processing systems as shown in FIGS. 3 and 4, the possible causes of the network failure and/or network connectivity through the first line 150, can include a plurality of causes including but not limited to: Cause #1, something wrong on the network cable (the first line 150), i.e., between the printer controller 130 and the hub 160; Cause #2, something wrong on the network cable (the first line 150) between the image forming apparatus 120 and the hub 160; Cause #3, something wrong in the hub 160; Cause #4, something wrong in the printer controller 130 and/or HTTP protocol; and/or Cause #5, something wrong in the hub 160 or hub connection.

In accordance with an exemplary embodiment, the diagnostic module (or diagnostic software application), which are preferably within the controllers 131, 121 of the printer controller 130 and the image forming apparatus 120, respectively, perform the following: Step 1, the printer controller 130 sends (or transmits) a message, which is preferably in the form of a ping command to printer controller 130 itself; Step 2, the printer controller 130 sends (transmits) a message (ping command) to the image forming apparatus 120 via the first line 150; Step 3, the image forming apparatus 120 sends (transmits) a message (ping command) to the printer controller 130 via the first line 150; and Step 4, the image forming apparatus 120 sends (transmits) a message (ping command) to the image forming apparatus 120 itself.

In accordance with an exemplary embodiment, the transmitted messages (or ping commands) can be used to check any destination IP address that the printer controller 130 and/or image forming apparatus 120 wishes to reach and record the results thereof. In accordance with an exemplary embodiment, the transmitted message (or ping command) can display (or determine) whether the destination (i.e., image forming apparatus 120 and/or printer controller 130) responded and how long it took to receive a reply (i.e., “Success”). If there is an error in the delivery to the destination, the printer controller 130 and/or image forming apparatus 120 will receive a transmitted message (or ping command), which displays an error message (i.e., “Failure”).

A transmitted message in the form of a ping command can be used to ping the device itself, i.e., the image forming apparatus 120 or printer controller 130 (by address, not host name) to determine if TCP/IP (Transmission Control Protocol (TCP) and the Internet Protocol (IP)) is functioning. However, sending a message (i.e., pinging) to the image forming apparatus 120 or printer controller 130 directly does not verify that the network adapter is functioning within the image forming apparatus 120 or the printer controller 130, respectively. In addition, as set forth above, a transmitted message (i.e., in the form of a ping command) via the first line 150 can be used to determine whether a hub 160 such as a switch or router is running, and/or alternatively, the image forming apparatus 120 and the printer controller 130 can transmit a message (i.e., a ping command) beyond the hub 160 via the first line 150, if needed to determine if other switches or routers are functioning.

In accordance with an exemplary embodiment, the diagnostic results given by the diagnostic module of the image forming apparatus 120 is forwarded via the second line to the diagnostic module of the printer controller 130, or vice versa, so that a complete set of the diagnostic results is gathered and stored in the printer controller 130 or the image forming apparatus 120. Specifically as shown in Table 1, each of the transmitted messages (or ping commands) and their corresponding test results are recorded or gathered within a storage medium or device associated with the image forming apparatus 120 and/or printer controller 130. If the ping command is successful (“Success), i.e., the transmitted message (or ping command) reaches its destination, a return message (or ping command) is received by the originating device (i.e., the image forming apparatus 120 or the printer controller 130). Alternatively, if a response of “Destination net unreachable” provides that there was no route to the destination (i.e., “Failure”). In accordance with an exemplary embodiment, the messages received and not received, which originated from the printer controller 130 are sent to the diagnostic module of the image forming apparatus 120 via the second line 152.

TABLE 1

| | Test (1) | Test (2) | Test (3) | Test (4) |
|---|---|---|---|---|
| Possible Cause #1 | Failure | Failure | Failure | Success |
| Possible Cause #2 | Success | Failure | Failure | Failure |
| Possible Cause #3 | Failure | Failure | Failure | Failure |
| Possible Cause #4 | Success | Success | Success | Success |
| Possible Cause #5 | Success | Failure | Failure | Success |

In accordance with an exemplary embodiment, the results from the at least one message, which have been sent by the image forming apparatus 120 and the printer controller 130 are recorded (or gathered) into a table of actual results and compared with a reference Table 1 as shown above. The diagnostic module within the image forming apparatus 120 compares the actual results with the reference table to determine a probable cause of the network connectivity failure.

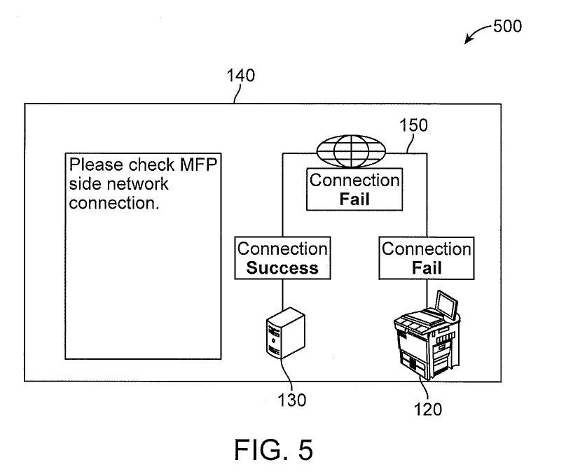

FIG. 5 is an illustration of a graphical user interface 500 for an image forming apparatus 120 in accordance with a further embodiment. As shown in FIG. 5, after the Web panel display problem occurs, in accordance with an exemplary embodiment, a diagnostic application or module, which is preferably hosted within both the image forming apparatus 120 and the printer controller 130. In accordance with an exemplary embodiment, the image forming apparatus 120 receives the diagnostic program or module results from the printer controller 130 (i.e., steps 1 and 2) via the second line 152 (i.e., video I/F or video interface cable). The image forming apparatus 120 compares the diagnostic results via an algorithmic program, which results are displayed on the display 140 of the image forming apparatus 120. As shown in FIG. 5, upon detection of a problem with network connectivity and/or cable interface, the display 140 can automatically convert or switch to a diagnostic solution box and/or image. The diagnostic solution box and/or image can include a text box showing the possible problems and associated solutions. In addition, the display 140 shows an image of the image forming apparatus 120, the printer controller 130, and the corresponding connection (i.e., first line 150) with symbols including “Success” and/or “Failure”.

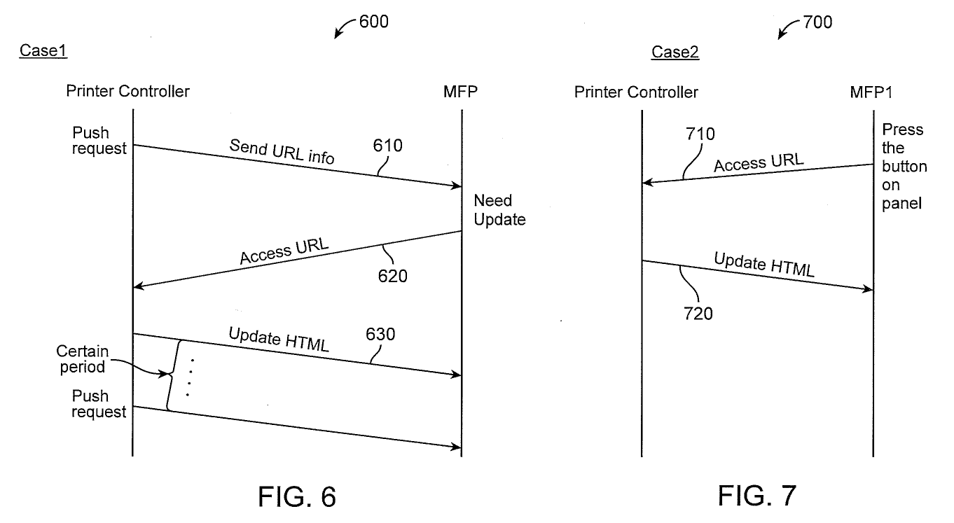

FIG. 6 is an illustration of a sequence diagram for an automatic network diagnostic feature 600 in accordance with another embodiment, wherein updates of network connectivity between the image forming apparatus 120 and the printer controller 130 are scheduled on a predetermined or preset schedule or time frame. The predetermined or preset schedule can be any time period upon which an administrator wishes to perform a diagnostic test to determine, if the network connectivity is still active or engaged. As shown in FIG. 6, in step 610, the printer controller 130 pushes via the second line a request (i.e., a message or ping command) for a status update to the image forming apparatus 120. The request is preferably in the form of a URL (Uniform Resource Locator) information request to the image fanning apparatus 120. In step 620, the image forming apparatus 120 receives the requests and accesses the URL of the printer controller 130 via the first line. In step 630, the printer controller 130 sends updates via a HTML (HyperText Markup Language) response at a predetermined period or periods of time to the image forming apparatus 120 via the first line. For example, once a request is sent from the printer controller 130, the printer controller 130 can send updates at any set period of time and/or other measurable increments.

FIG. 7 is an illustration of a sequence diagram, which describes the automatic network diagnostic feature in accordance with an exemplary embodiment, wherein the image forming apparatus 120 and printer controller 130 receive updates upon request. As shown in FIG. 7, in step 710, the image forming apparatus 120 sends or pushes via the first line an access URL to the printer controller 130 upon request of a user, which can be activated by pushing or activating a control button on the display panel 140 of the image forming apparatus 120. The printer controller 130 in step 720 receives the request and sends via the first line an update HTML to the image forming apparatus 120 providing the status of the network connectivity.

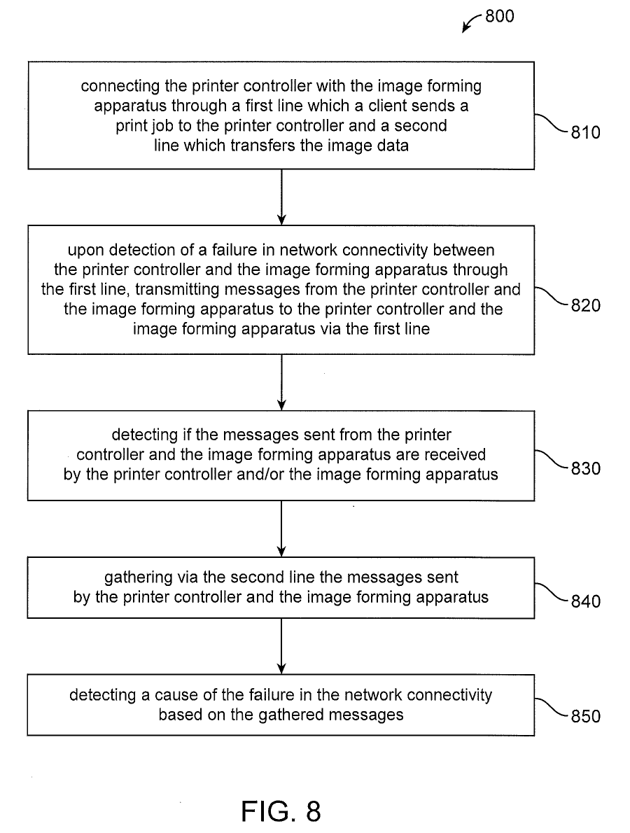

FIG. 8 is an illustration of a flowchart of a method of detecting and displaying network status for an image forming system having an image forming apparatus and a printer controller 800 in accordance with an exemplary embodiment. In step 810, the printer controller is connected with the image forming apparatus through a first line which a client sends a print job to the printer controller and a second line which transfers the image data. In step 820, upon detection of a failure in network connectivity between the printer controller and the image forming apparatus through the first line, transmitting messages from the printer controller to the printer controller and the image forming apparatus via the first line, and transmitting messages from the image forming apparatus to the printer controller and the image forming apparatus via the first line, wherein upon receipt of the messages, the printer controller and the image forming apparatus receiving the messages sends a return message to the printer controller or image forming apparatus which originated the message. In step 830, the printer controller and the image forming apparatus detect if the messages sent from the printer controller and the image forming apparatus are received by the printer controller and/or the image forming apparatus by receiving via the first line a return message from the printer controller and/or the image forming apparatus. In step 840, the messages sent by the printer controller and the image forming apparatus, which are received by the printer controller and the image forming apparatus via the return message, and messages sent by the printer controller and the image forming apparatus, which do not return to the printer controller and the image forming apparatus are gathered via the second line. In step 850, a cause of the failure in the network connectivity between the printer controller and the image forming apparatus is detected based on the gathered messages received and not received by the image forming apparatus and the printer controller.

In accordance with another exemplary embodiment, a computer program product comprising a non-transitory computer usable medium having a computer readable code embodied therein for detecting and displaying network status for an image forming system having an image forming apparatus and a printer controller, the computer readable program code configured to execute a process, which includes the steps of: connecting the printer controller with the image forming apparatus through a first line which a client sends a print job to the printer controller and a second line which transfers the image data; upon detection of a failure in network connectivity between the printer controller and the image forming apparatus through the first line, transmitting messages from the printer controller to the printer controller and the image forming apparatus via the first line, and transmitting messages from the image forming apparatus to the printer controller and the image forming apparatus via the first line, wherein upon receipt of the messages, the printer controller and the image forming apparatus receiving the messages sends via the first line a return message to the printer controller or image forming apparatus which originated the message; detecting if the messages sent from the printer controller and the image forming apparatus are received by the printer controller and/or the image forming apparatus by receiving via the first line a return message from the printer controller and/or the image forming apparatus; gathering via the second line the messages sent by the printer controller and the image forming apparatus, which are received by the printer controller and the image forming apparatus via the return message, and messages sent by the printer controller and the image forming apparatus, which do not return to the printer controller and the image forming apparatus; and detecting a cause of the failure in the network connectivity between the printer controller and the image forming apparatus based on the gathered messages received and not received by the image forming apparatus and the printer controller.

The computer usable medium, of course, may be a magnetic recording medium, a magneto-optic recording medium, or any other recording medium which will be developed in future, all of which can be considered applicable to the present invention in all the same way. Duplicates of such medium including primary and secondary duplicate products and others are considered equivalent to the above medium without doubt. Furthermore, even if an embodiment of the present invention is a combination of software and hardware, it does not deviate from the concept of the invention at all. The present invention may be implemented such that its software part has been written onto a recording medium in advance and will be read as required in operation.

It will be apparent to those skilled in the art that various modifications and variation can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of detecting and displaying network status for an image forming system having an image forming apparatus and a printer controller, the method comprising:
connecting the printer controller with the image forming apparatus through a first line which a client sends a print job to the printer controller and a second line which transfers the image data;
upon detection of a failure in network connectivity between the printer controller and the image forming apparatus through the first line, transmitting messages from the printer controller to the printer controller and the image forming apparatus via the first line, and transmitting messages from the image forming apparatus to the printer controller and the image forming apparatus via the first line, wherein upon receipt of the messages, the printer controller and the image forming apparatus receiving the messages sends via the first line a return message to the printer controller or image forming apparatus which originated the message;
detecting if the messages sent from the printer controller and the image forming apparatus are received by the printer controller and/or the image forming apparatus by receiving via the first line a return message from the printer controller and/or the image forming apparatus;
gathering via the second line the messages sent by the printer controller and the image forming apparatus, which are received by the printer controller and the image forming apparatus via the return message, and messages sent by the printer controller and the image forming apparatus, which do not return to the printer controller and the image forming apparatus; and
detecting a cause of the failure in the network connectivity between the printer controller and the image forming apparatus based on the gathered messages received and not received by the image forming apparatus and the printer controller.

2. The method of claim 1, wherein the first line is an Internet line and the second line is a dedicated bus line.

3. The method of claim 1, further comprising at least one hub, which is connected to the printer controller and the image forming apparatus via the first line.

4. The method of claim 3, wherein the at least one hub is a plurality of hubs, which are connected in series to the printer controller and the image forming apparatus via the first line.

5. The method of claim 1, wherein the messages sent by the printer controller and image forming apparatus are ping commands.

6. The method of claim 1, further comprising;
transmitting panel information of the printer controller as HTTP data via the first line to the image forming apparatus;
displaying the panel information on a display on the image forming apparatus using a Web browser function; and
displaying the possible cause of the failure in the network connectivity via the display on the image forming apparatus.

7. The method of claim 1, further comprising transmitting the messages from the printer controller and the image forming apparatus at a predetermined time interval to obtain a status of the network connectivity between the printer controller and the image forming apparatus before the detection of the failure in the network connectivity between the printer controller and the image forming apparatus.

8. The method of claim 1, further comprising generating an actual table of the messages received and not received, and comparing the actual table to a reference table to determine the cause of the failure in the network connectivity between the printer controller and the image forming apparatus.

9. The method of claim 1, further comprising:
executing an initial setting by using the first line for enabling the printer controller to be used through the second line;
executing a control of the printer controller after the initial setting by using the second line;
allowing the printer controller to function as a Web server which provides a Web page for controlling the printer controller; and
allowing the image forming apparatus to function as a Web browser which obtains and displays the Web page, wherein the initial setting is executed by a command sent through the first line from image forming apparatus, and the control after the initial setting is executed on the Web page which the Web browser has obtained through the second line from the Web server.

10. The method of claim 9, wherein the image forming apparatus sends to the printer controller information which specifies a content which can be displayed on the Web browser, and the printer controller generates the Web page suitable for displaying on the Web browser of the image forming apparatus based on the information.

11. An image forming system comprising:
a printer controller which generates image data based on a print job, the printer controller having a diagnostic module;
an image forming apparatus which controls the printer controller and performs a printing operation based on the image data, and wherein the printer controller is connected with the image forming apparatus through a first line which a client sends a print job to the printer controller and a second line which transfers the image data; and
wherein the printer controller and the image forming apparatus perform the following steps:
connecting the printer controller with the image forming apparatus through the first line which the client sends the print job to the printer controller and the second line which transfers the image data;
upon detection of a failure in network connectivity between the printer controller and the image forming apparatus through the first line, transmitting messages from the printer controller to the printer controller and the image forming apparatus via the first line, and transmitting messages from the image forming apparatus to the printer controller and the image forming apparatus via the first line, wherein upon receipt of the messages, the printer controller and the image forming apparatus receiving the messages sends via the first line a return message to the printer controller or image forming apparatus which originated the message;
detecting if the messages sent from the printer controller and the image forming apparatus are received by the printer controller and/or the image forming apparatus by receiving via the first line a return message from the printer controller and/or the image forming apparatus;
gathering via the second line the messages sent by the printer controller and the image forming apparatus, which are received by the printer controller and the image forming apparatus via the return message, and messages sent by the printer controller and the image forming apparatus, which do not return to the printer controller and the image forming apparatus; and
detecting a cause of the failure in the network connectivity between the printer controller and the image forming apparatus based on the gathered messages received and not received by the image forming apparatus and the printer controller.

12. The system of claim 11, wherein the messages received and not received originating from the printer controller are sent to the diagnostic module of the image forming apparatus via the second line.

13. The system of claim 11, wherein the first line is an Internet line and the second line is a dedicated bus line.

14. The system of claim 11, further comprising at least one hub, which is connected to the printer controller and the image forming apparatus via the first line.

15. The system of claim 14, wherein the at least one hub is a plurality of hubs, which are connected in series to the printer controller and the image forming apparatus via the first line.

16. The system of claim 11, wherein the messages sent by the printer controller and image forming apparatus are ping commands.

17. The system of claim 11, wherein the printer controller has a function as a Web server which provides a Web page for controlling the printer controller; the image forming apparatus has a function as a Web browser which obtains and displays the Web page; the initial setting is executed through the first line by a command sent from image forming apparatus; and the control after the initial setting is executed through the second line on the Web page which the Web browser has obtained from the Web server.

18. A computer program product comprising a non-transitory computer usable medium having a computer readable code embodied therein for detecting and displaying network status for an image forming system having an image forming apparatus and a printer controller, the computer readable program code configured to execute a process, which includes the steps of:
connecting the printer controller with the image forming apparatus through a first line which a client sends a print job to the printer controller and a second line which transfers the image data;
upon detection of a failure in network connectivity between the printer controller and the image forming apparatus through the first line, transmitting messages from the printer controller to the printer controller and the image forming apparatus via the first line, and transmitting messages from the image forming apparatus to the printer controller and the image forming apparatus via the first line, wherein upon receipt of the messages, the printer controller and the image forming apparatus receiving the messages sends via the first line a return message to the printer controller or image forming apparatus which originated the message;
detecting if the messages sent from the printer controller and the image forming apparatus are received by the printer controller and/or the image forming apparatus by receiving via the first line a return message from the printer controller and/or the image forming apparatus;
gathering via the second line the messages sent by the printer controller and the image forming apparatus, which are received by the printer controller and the image forming apparatus via the return message, and messages sent by the printer controller and the image forming apparatus, which do not return to the printer controller and the image forming apparatus; and
detecting a cause of the failure in the network connectivity between the printer controller and the image forming apparatus based on the gathered messages received and not received by the image forming apparatus and the printer controller.

19. The computer program of claim 18, further comprising:
transmitting panel information of the printer controller as HTTP data via the first line to the image forming apparatus;
displaying the panel information on a display on the image forming apparatus using a Web browser function; and
displaying the possible cause of the failure in the network connectivity via the display on the image forming apparatus.
